(19) United States
(12) Patent Application Publication
(10) Pub. No.: US 2026/0091778 A1
(43) Pub. Date: Apr. 2, 2026

(54) Detection and Mitigation of Slow Crossing Hazards for Autonomous Vehicles

(71) Applicant: Nissan North America, Inc., Franklin, TN (US)

(72) Inventors: Qizhan Tam, San Jose, CA (US); Christopher Ostafew, Mountain View, CA (US)

(21) Appl. No.: 18/902,302

(22) Filed: Sep. 30, 2024

(51) Int. Cl. B60W 30/09; B60W 30/095; B60W 60/00

(52) U.S. Cl. CPC B60W 30/09; B60W 30/0953; B60W 30/0956; B60W 60/0015; B60W 2554/404

(57) ABSTRACT

A method includes obtaining a risk field comprising an evidence grid established in a map frame associated with an autonomous vehicle and obtaining a reference path associated with the autonomous vehicle. The reference path is based on a drive plan and driveline data. The method includes accumulating slow crossing hazard (SCH) data in the evidence grid by performing at least one of a boundary intrusion detection procedure, an object intrusion detection procedure, or a lead vehicle hazard detection procedure. The SCH data is provided to a process within an autonomous vehicle for further decision-making or risk mitigation.

### TECHNICAL FIELD

This application relates generally to autonomous vehicles, and more specifically to detection and mitigation of slow crossing hazards.

### BACKGROUND

Autonomous vehicles (AVs) are designed to navigate complex environments that are often filled with various hazards, both static and dynamic. These hazards can include other vehicles, pedestrians, cyclists, and unexpected obstacles such as debris or construction zones. For autonomous vehicles to operate safely and efficiently, it is critical to detect these hazards accurately and assess their potential impact on the vehicle's path. Proper hazard detection and assessment enable the vehicle to make informed decisions, avoid collisions, and ensure a smooth and safe driving experience.

### SUMMARY

Disclosed herein are aspects, features, elements, and embodiments for evidence grid for vehicle navigation.

A first aspect is a method that includes obtaining a risk field comprising an evidence grid established in a map frame associated with an autonomous vehicle; obtaining a reference path associated with the autonomous vehicle, wherein the reference path is based on a drive plan and driveline data; accumulating slow crossing hazard (SCH) data in the evidence grid by performing at least one of a boundary intrusion detection procedure, an object intrusion detection procedure, or a lead vehicle hazard detection procedure; and providing the SCH data to a process within the autonomous vehicle for further decision-making or risk mitigation.

A second aspect is a vehicle that includes a memory and a processor. The processor is configured to execute instructions stored in the memory to obtain a risk field comprising an evidence grid established in a map frame associated with an autonomous vehicle; obtain a reference path associated with the autonomous vehicle, wherein the reference path is based on a drive plan and driveline data; accumulate slow crossing hazard (SCH) data in the evidence grid by performing at least one of a boundary intrusion detection procedure, an object intrusion detection procedure, or a lead vehicle hazard detection procedure; and provide the SCH data to a process within the autonomous vehicle for further decision-making or risk mitigation.

A third aspect is a non-transitory computer-readable medium storing instructions operable to cause one or more processors to perform operations. The operations include obtaining a risk field comprising an evidence grid established in a map frame associated with an autonomous vehicle; obtaining a reference path associated with the autonomous vehicle, wherein the reference path is based on a drive plan and driveline data; accumulating slow crossing hazard (SCH) data in the evidence grid by performing at least one of a boundary intrusion detection procedure, an object intrusion detection procedure, or a lead vehicle hazard detection procedure; and providing the SCH data to a process within the autonomous vehicle for further decision-making or risk mitigation.

These and other aspects of the present disclosure are disclosed in the following detailed description of the embodiments, the appended claims, and the accompanying figures.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is an overview of a process for maintaining a risk field.

FIG. 4A illustrates an example of an evidence grid at different points in time.

FIG. 4B illustrates an example of identifying non-drivable grid cells in an evidence grid.

FIG. 4C illustrates an example of risk field classification.

FIG. 5A-5B illustrate the accumulation phase of hazard evidence into an evidence grid.

FIG. 6 is a block schematic diagram of an example of a process for navigating an autonomous vehicle in accordance with the present disclosure.

FIG. 7 is a block schematic diagram of an example of a process for detecting and mitigating slow crossing hazards in accordance with the present disclosure.

FIGS. 8A-8H illustrate an example of a boundary intrusion detection process in accordance with the present disclosure.

FIGS. 9A-9G illustrate an example of an object intrusion detection process in accordance with the present disclosure.

FIGS. 10A-10F illustrate an example of lead vehicle intrusion detection process in accordance with the present disclosure.

FIG. 11 is a flowchart of an example of a technique for navigating an autonomous vehicle in accordance with the present disclosure.

### DETAILED DESCRIPTION

AVs frequently encounter various potential hazards, both static and dynamic, such as parked vehicles, pedestrians, and other moving objects. Proactive risk mitigation (PRM) is an approach to automatically mitigate risks from such hazards, ensuring a safe and human-like driving experience. However, current PRM approaches have two main drawbacks: they accumulate and track hazards relative to the path of the ego vehicle (i.e., the AV itself), requiring a reset of the accumulated hazard data whenever the path changes; and the hazard data and risk zones are only used within PRM, preventing other processes executing within the AV from accessing this valuable information.

In some cases, to mitigate these drawbacks, an AV may maintain and utilize a risk field through an evidence grid. Unlike a conventional occupancy grid parser, the risk field accumulates non-drivable points, objects, and hazards in the map frame. This map-based accumulation retains the probability and belief of obstacle and hazard locations, allowing for the immediate use of previously accumulated information, even when the path changes.

The risk field approach can offer several advantages over traditional path-based and occupancy grid implementations. One of the benefits is that accumulated data about hazards and objects remain even when the ego vehicle's reference path changes or resets. This retention of data leads to greater stability and smoother driving, as systems like PRM can utilize the hazard data from the risk field without needing to re-accumulate information. Additionally, the tiered approach to hazard accumulation ensures that the risk field remains useful even without the ego vehicle's reference path, making hazard assessment robust and reliable.

The evidence grid approach in the risk field classifies objects and accumulates visible space and non-drivable areas irrespective of the path of the ego vehicle. This means historical accumulations are maintained and reused if the path of the ego vehicle changes. Furthermore, the risk field accumulates the future positions of hazards where they are predicted to interact with the ego vehicle over time based on the vehicle's path. This allows for a more comprehensive and dynamic understanding of the environment, enhancing the safety and efficiency of the navigation of the ego vehicle. Another advantage is that hazard data and risk zones can now be made available to other modules or executing processes of the ego vehicle. This opens up new possibilities, such as visualizing risk zones for driver assistance, enhancing overall safety and situational awareness. The risk field also improves hazard and object association, effectively mitigating issues related to duplicated objects, occluded objects, and the erroneous labeling of previously tracked world model objects as new.

By accumulating all hazards and objects on a grid in a map frame, multiple hazards can be tracked and evaluated within an area as a group, rather than individually. This holistic approach allows for more comprehensive risk assessment and management, ensuring that the ego vehicle can navigate complex environments with greater accuracy and safety.

To enhance the usefulness of the risk field approach described above, some implementations address challenges with detecting and mitigating slow crossing hazards (SCHs), such as vehicles backing out of driveways or making turning maneuvers, in parking lots and residential areas. Some systems can struggle to detect these hazards due to their slow speed, which can be mistaken for sensor noise, and their late detection due to occlusion. Implementations described herein provide an approach that provides redundancy in the planner by detecting intrusions from slow crossing hazards and responding to them in a safe and socially compliant manner.

As discussed above, the risk field approach offers several advantages over traditional path-based and occupancy grid implementations, including the retention of hazard data even when the ego vehicle's reference path changes or resets, and the ability to access hazard data and risk zones from other modules within the AV. Various implementations described herein utilize the risk field to detect slow crossing hazards through two parallel systems: boundary intrusion detection and object-based detection. Boundary intrusion detection tracks non-drivable points, which appear as soon as the edge of a vehicle protrudes into the field of sensor vision, leading to faster detection and classification of slow crossing hazards. Object-based detection tracks slow or stationary objects and classifies them as possible slow crossing hazards based on their boundary intrusion motion. Both systems contribute to a faster speed mitigation response, and if either system fails, the other system can still detect slow crossing hazards.

To describe some embodiments of detecting and mitigating SCHs for vehicle navigation according to the teachings herein in greater detail, reference is first made to the environment in which this disclosure may be implemented.

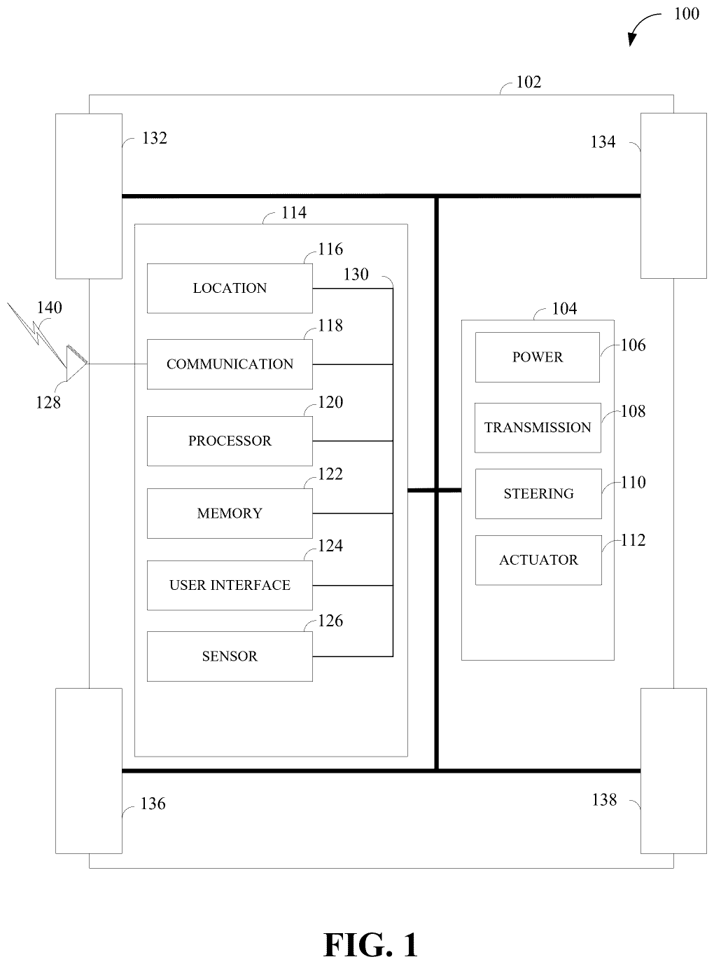

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals; power, such as electrical power or torque; or both information and power may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices. The processor 120 may also implement some or all of the proactive risk mitigation described herein.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), Institute of Electrical and Electronics Engineers (IEEE) 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller.

For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

The vehicle, such as the vehicle 100, may be an autonomous vehicle or a semi-autonomous vehicle. For example, as used herein, an autonomous vehicle as used herein should be understood to encompass a vehicle that includes an advanced driver assist system (ADAS).

An ADAS can automate, adapt, and/or enhance vehicle systems for safety and better driving such as by circumventing or otherwise correcting driver errors.

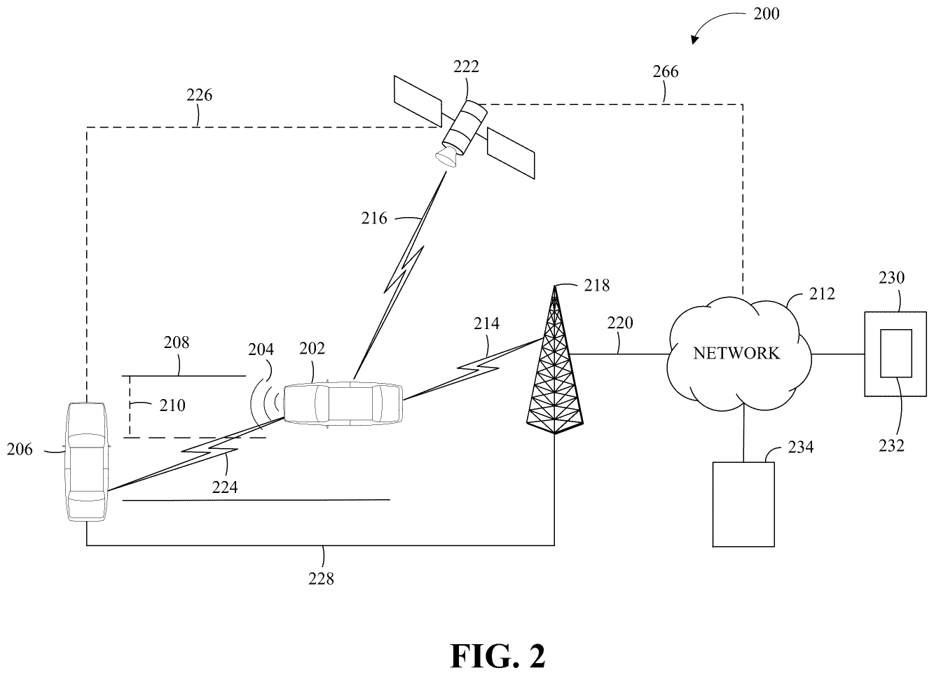

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some embodiments, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

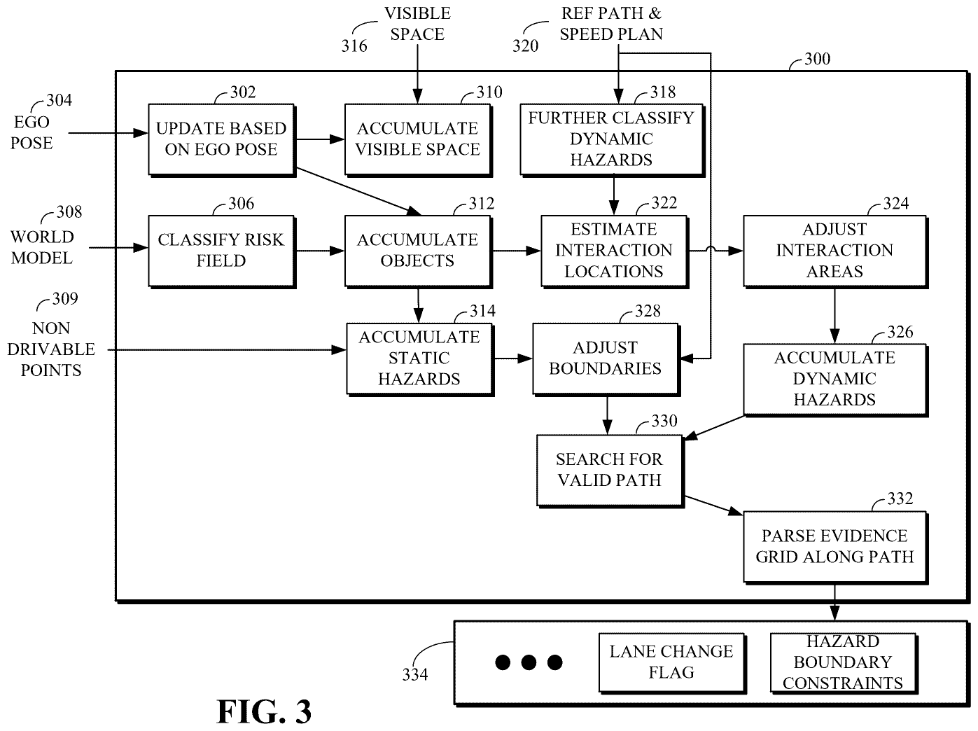

FIG. 3 is an overview of a process 300 for maintaining a risk field. The process 300 can be implemented by an ego vehicle, which may be the same as or similar to the vehicle 100 or the vehicle 202 of FIG. 2. Maintaining the risk field can mean or include maintaining an evidence grid, as further described herein.

The process 300 can be implemented by one or more tools, such as programs, subprograms, functions, routines, subroutines, operations, executable instructions, and/or the like for, inter alia and as further described below, maintaining the risk field. At least some of the tools can be implemented as respective software programs that may be executed by one or more processors, such as the processor 120 of FIG. 1. A software program can include machine-readable instructions that may be stored in a memory such as the memory 122 of FIG. 1, and that, when executed by the processor, may cause the vehicle to perform the instructions of the software program. At least some steps, or operations, of the process 300 or another technique, method, process, or algorithm described in connection with the implementations disclosed herein can be implemented directly in hardware, firmware, software executed by hardware, circuitry, or a combination thereof.

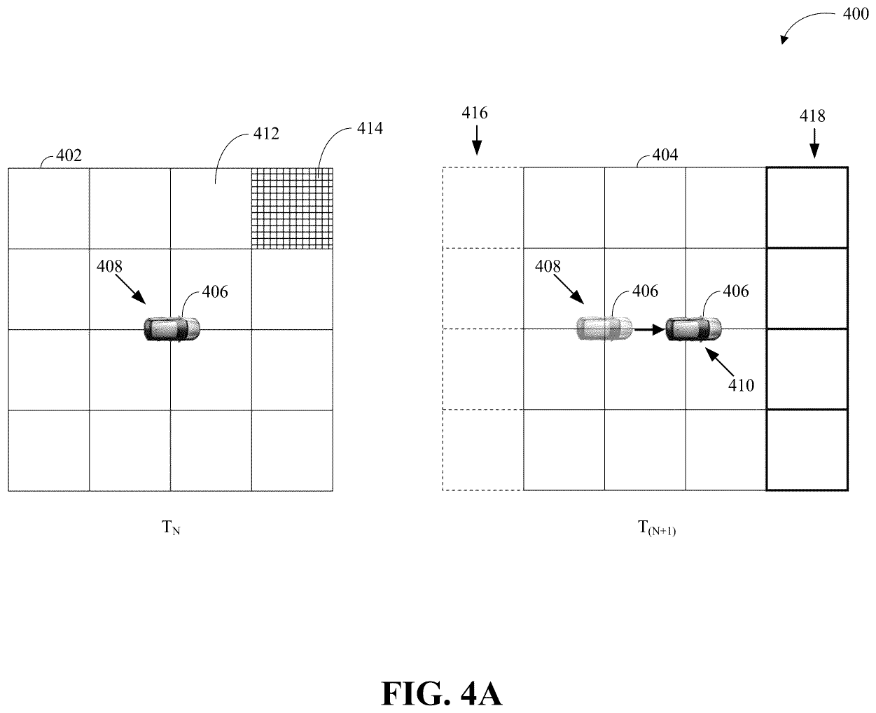

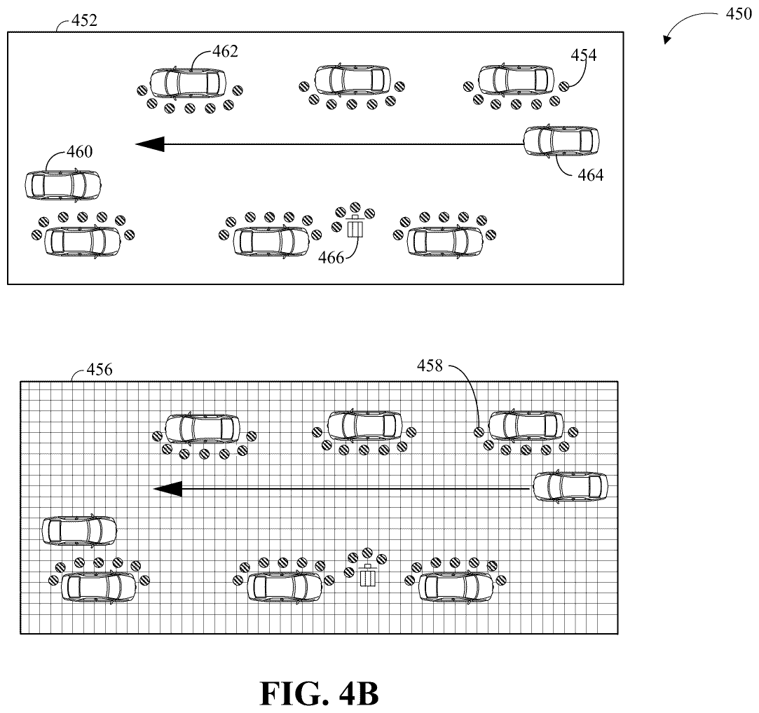

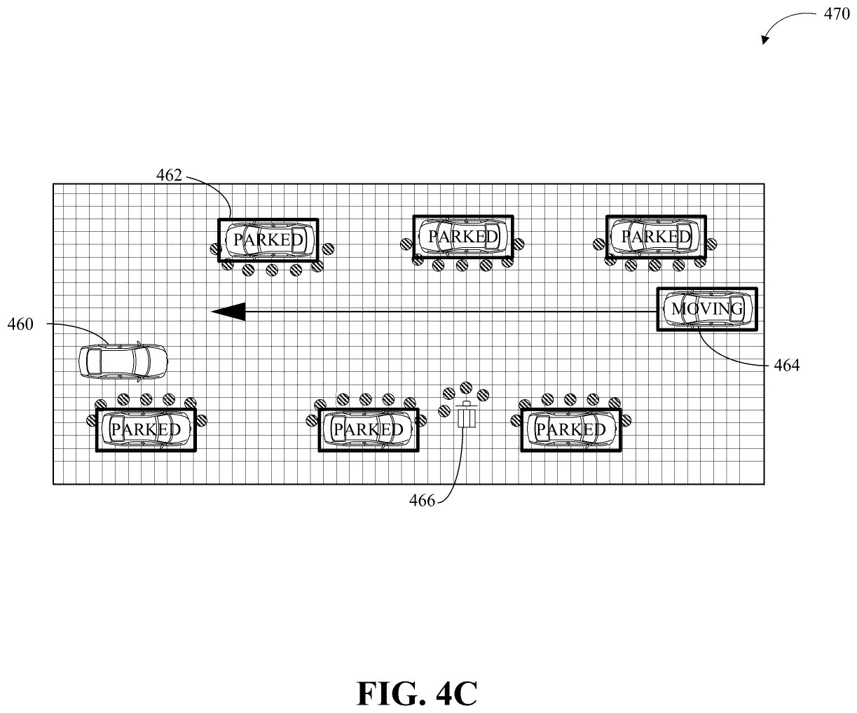

At 302, the evidence grid is updated based on a pose 304 of the ego vehicle. The pose 304 can be received as an input to the process 300. The pose 304 refers to the position and orientation of the ego vehicle within the environment. This includes the coordinates (e.g., latitude and longitude) and heading or direction of travel of the ego vehicle. Updating the evidence grid based on the pose of the ego vehicle provides a consistent frame of reference for tracking hazards, independent of the path or speed of the ego vehicle. This allows for seamless integration with the risk field, enhancing the vehicle's ability to navigate safely by leveraging accumulated hazard data. Updating the evidence grid can be as described with respect to FIG. 4A. Updating the evidence can also include identifying (e.g., marking) grid cells as non-drivable points in the evidence grid, as described with respect to FIG. 4B.

GPS data can be used to identify the location of the ego vehicle. That is, the GPS data is said to be used to localize the ego vehicle. Localizing the ego vehicle includes identifying the portion of a map (such as a high-precision, high-definition (HD) map) for which the evidence grid is established (e.g., maintained or updated). HD map data from an HD map can be used by an autonomous vehicle, such as the ego vehicle. The HD map data can include accurate information regarding a vehicle transportation network to within a few centimeters. For example, the HD map data can include details regarding road lanes, road dividers, traffic signals, traffic signs, speed limits, and the like.

FIG. 4 illustrates an example 400 of an evidence grid at different points in time.

Initially (such as when the ego vehicle starts), a titled evidence grid is established around the ego vehicle. At each point in time (e.g., as the ego vehicle proceeds forwards or backwards), the updated pose of the ego vehicle is compared against the existing evidence grid tiles.

The evidence grid is a two-dimensional (2D) grid structure that accumulates evidence of hazards which may interact with the ego vehicle. The evidence grid is represented in a memory, such as the memory 122 of FIG. 1, by one or more suitable data structures. In one implementation, one single evidence grid can be maintained and temporal data (e.g., interaction zones) may be overlayed thereon. In another implementation, an evidence grid can be separately maintained for each time step. In both implementations, the evidence grids can be visualized as described herein.

The grid consists of multiple cells, each representing a small area in the environment surrounding the ego vehicle. Data stored within (e.g., in association with) the grid cells can include object identifiers, hazard types, sensor visibility, and the probability that a hazard is present, amongst other data, and as further described herein. The evidence grid serves as a foundational element of the risk field, enabling the ego vehicle (i.e., the process 300 executing therein) to identify, track, and predict hazards dynamically. The risk field leverages the evidence grid to classify, accumulate, and manage both static and dynamic hazards, ensuring a comprehensive and real-time assessment of the surrounding environment, as further described herein.

At time T_{N}, an evidence grid 402 is centered around the ego vehicle 406, which has a pose 408. The evidence grid 402 consists of multiple tiles, each representing a segment of the environment surrounding the ego vehicle 406. The environment is partitioned into tiles, such as a tile 412. Each tile is further partitioned into multiple grid cells (e.g., smaller grid cells), such as a grid cell 414. The smaller grid cells are used for higher resolution tracking of hazards or objects. At a subsequent time T_{(N+1)}, the evidence grid 404 has shifted to accommodate the movement of the ego vehicle 406 to a new pose 410. To illustrate the scale of the evidence grid, and without limitations, the evidence grid may include 16 tiles, each tile having a size of 50 meters by 50 meters; and each tile may be further partitioned into smaller grid cells, each with a size of 0.5 meters by 0.5 meters.

As the ego vehicle 406 moves, new grid tiles 418 are created in the direction of the movement (according to the new pose 410), while old grid tiles 416 that are no longer relevant are discarded. Grid tiles may be deemed irrelevant when they fall outside the sensor range of the ego vehicle for at least a minimum duration of time. Discarding these outdated tiles helps to optimize memory usage and computational efficiency, ensuring that the system focuses on the most pertinent and current environmental data. This dynamic updating of the evidence grid ensures that the surroundings of the ego vehicle are continuously and accurately maintained, enabling effective hazard detection and risk management.

Each grid cell represents (e.g., occupies) a small area and is used to store evidence (e.g., data) of a hazard's presence in that grid cell. As mentioned, appropriate data structures may be associated with each tile and with each grid cell. As further described herein, object identifiers, hazard types, and sensor visibility may be associated with each grid cell. Additionally, with respect to hazards (i.e., objects) determined to occupy a grid cell, respective probabilities may also be associated with the hazards, indicating the degrees of certainty that the hazards are indeed present in the grid cell.

To improve memory efficiency, data of a particular hazard occupying multiple grid cells can be shared among the grid cells. In an implementation, all identified world objects may be stored in a shared data structure (e.g., a hash table). Each world object stored in the shared data structure can be associated with, or assigned, an object identifier (i.e., an object ID). If an object is determined to occupy more than one grid cell, then its object ID can be stored in association with the more than one grid cells. However, some evidence data may not be shareable between grid cells. For example, the probabilities cannot be shared between cells because, for example, each grid cell represents a unique area with its own associated set of sensor readings and environmental factors, leading to different levels of certainty for the presence of the object in each specific location (e.g., grid cell).

FIG. 4B illustrates an example 450 of identifying non-drivable grid cells in an evidence grid. Non-drivable grid cells are also referred to as non-drivable points. The non-drivable points can be identified based on sensor data, such as LiDAR data. The LiDAR data can be the non-drivable points 309 received from a perception module of the ego vehicle. The example 450 illustrates a scene 452 that includes several world objects. Sensor data is used to identify the non-drivable points. The sensor data indicates the existence of stationary boundaries in the scene 452. The non-drivable points, such as a non-drivable point 454, are shown as white-filled circles. A grid 456 of grid cells (i.e., grid cells of the evidence grid) is overlaid over the scene 452. The grid cells corresponding to the non-drivable points are then marked as non-drivable points. As such, a grid cell 458, corresponding to the non-drivable point 454, is marked as a non-drivable point.

Referring again to FIG. 3, at 306, world objects are classified into different hazard types. The world objects that are classified can be included in (e.g., retrieved from) a world model 308 that may be maintained (e.g., updated) by a world model module (not shown) of the ego vehicle. For example, the process 300 may classify a world object into one of a parked vehicle, a moving vehicle, a moving pedestrian, or a set of non-drivable points. Non-drivable points correspond to a detected hazard that cannot be classified into a particular type of object.

Examples of non-drivable points include trash cans or curbs. The hazards can be categorized into static hazards or dynamic hazards. Static hazards can be hazards that have not been observed moving and are not expected to be moving soon. Dynamic hazards can be either already in motion or have a high probability of moving soon.

For at least some detected world objects (e.g., a vehicle, a pedestrian, or a bicycle), the world model module can maintain (e.g., predict and update) one or more hypothesis regarding the possible intentions of that world object. Examples of intentions (e.g., hypotheses) include stop, turn right, turn left, go straight, pass, and park. A likelihood may be associated with each hypothesis. The likelihood can be updated based on observations received from sensor data. The world objects are detected based on received sensor data (sensor measurements or sensor observations). The world model module maintains (i.e., associates and updates over time) a state for each hypothesis (e.g., intention) associated with a world object. For example, the state may include predicted locations of the associated world object given the intention of a hypothesis.

The world model module continuously receives sensor data (sensor observations). For a given observation, the world model module identifies the world object that the observation is associated with. If an associated world object is found, then the state of each of the hypotheses associated with real-world object are updated based on the observation (e.g., based on the consistency of the observation with the hypothesis). That is, for example, the predicted location of the world object is updated based on the observation received from the real (e.g., physical) world. In summary, the world object model can include world objects and their details as fused based on sensor data. The details can include poses, velocities, and predictions regarding different hypotheses.

Certain hazards, such as moving vehicles, may later (e.g., at 318) be sub-classified, such as into a parallel vehicle, an oncoming vehicle, or other sub-classification. Such sub-classifications could not be determined at this stage (i.e., at 306) of the process 300 due to the lack of path information of the ego vehicle. That is, the world objects cannot be sub-classified without knowing at least the reference path of the ego vehicle.

FIG. 4C illustrates an example 470 of risk field classification. The example 470 illustrates classifying world objects of the scene 450 of FIG. 4B. The world model of an ego vehicle 460 of the scene 450 includes an object 462, an object 464, and an object 466, amongst others. The process 300 classified the objects into different hazard types. The object 462 is classified as a parked vehicle, the object 464 is classified as a moving vehicle, and the object 466 is classified as an unknown object. Since, at this point in the process 300, no reference path information of the ego vehicle 460 is available (e.g., is available to the process 300), any moving objects (such as the object 464) cannot be further sub-classified (such as into a leading vehicle, an oncoming vehicle, a following vehicle, a parallel vehicle, etc.).

At an accumulation stage of the process 300, an accumulation phase within each grid cell of the evidence grid is performed. The accumulation phase includes accumulating visible space in the evidence grid, at 310; accumulating objects in the evidence grid, at 312; and accumulating static hazards in the evidence grid, at 314. During the accumulation phase, the evidence grid is populated with data that provides a comprehensive view of the environment (i.e., the risk field) surrounding the ego vehicle.

In the accumulation phase, the static objects and non-drivable points are processed to accumulate evidence of static hazards and non-drivable points in each grid cell of each tile. The accumulation phase can include storing hazard information associated with each hazard and the presence of a hazard is assigned to each grid cell that the hazard occupies; and at each time step, increasing/decreasing the probability that the hazard exists in the grid cell that the hazard occupies. Thus, the lack of occupancy decreases existing hazard probabilities within each grid cell. Visible space is also accumulated in the evidence grid. At each time step, the visibility level of a grid cell that is within the line-of-sight of the sensors of the ego vehicle increases therewith measuring the visibility level of the grid cell location. The longer and more consistent that the grid cell is visible, the higher the visibility level of that location. The visibility level of a grid cell is referred to herein as a visibility probability.

Visibility probability is a metric that quantifies the extent to which a grid cell is determined to be visible to the sensors of the ego vehicle. The visibility probability can be calculated based on the frequency and consistency of sensor detections over time. A higher visibility probability indicates that a grid cell has been consistently detected by the sensors, suggesting a higher degree of confidence in the visibility of that grid cell. Conversely, a lower visibility probability indicates less frequent or inconsistent detections. The visibility probability metric helps in distinguishing grid cells with reliable sensor coverage from those with potential occlusions or intermittent visibility.

At 310, visible space is accumulated in the evidence grid based on a visible space 316 received from a perception module of the ego vehicle. The visible space includes visible grid cells. The perception module processes sensor data from various sources such as cameras, LiDAR, and radar to determine the areas around the ego vehicle that are currently visible. This visible space information is then integrated into the evidence grid, where each grid cell is updated to reflect the visibility status. Cells within the line-of-sight of the ego vehicle's sensors will have higher visibility values, while occluded or obstructed cells will have lower visibility values. Visibility probabilities are associated with grid cells to indicate the degrees of certainty that the grid cells are visible. The visible space can be used to determine, for example, the extent and quality of the sensor coverage around the ego vehicle. Colloquially, the visible space can be used to determine how far and what the ego vehicle can “see.”

At 312, objects within the environment are accumulated in the evidence grid. These objects can include other vehicles, pedestrians, cyclists, and various obstacles detected by the ego vehicle's sensors. Each detected world object is assigned an object ID and classified into different hazard types.

At 314, static hazards are accumulated in the evidence grid. Static hazards refer to non-moving obstacles such as parked cars, curbs, trash cans, and construction barriers. These hazards are detected by the perception module and their positions are recorded in the grid cells they occupy. Unlike dynamic objects, static hazards do not change position, but their continuous monitoring is essential to ensure safe navigation. The probabilities of the presence of these static hazards in grid cells are updated in the evidence grid based on repeated sensor readings, improving the reliability of the hazard data.

The probabilities (i.e., hazard presence probabilities) associated with the presence of hazards in the grid cells may both increase and decrease at each time step. The longer a hazard occupies a cell, the higher the probability that the hazard exists in that grid cell. Conversely, if a hazard, such as a parked car, is no longer detected as the ego vehicle approaches, it may indicate a false identification or false classification. In such cases, the probability of the hazard's presence will gradually decrease and fade into the background, losing its accumulated probability.

Probabilities may decrease due to several factors, including the absence of a previously detected object in subsequent sensor readings or the detection of an object being less certain due to increased sensor noise or environmental conditions. As such, the risk field can be more robust to noise, prediction errors, and tracking sensor noise because objects can appear (e.g., be perceived) and disappear (e.g., not be perceived) from sensor detection, especially in low visibility areas. The process 300 can evaluate how confident it is that a hazard or object is present in a grid cell. For example, if an object is behind a bush, visibility might be intermittent, leading to fluctuating confidence levels. Therefore, the probability values provide a measure of confidence regarding the presence of a hazard in a specific area.

Probability scaling can be used to adjust the likelihood values of detected objects based on the confidence levels in the sensor data. The probability scaling can be influenced by the certainty of the object detection. For instance, when utilizing a sensor source with low noise levels, such as LiDAR, there is higher confidence in the detection accuracy. Therefore, the probability of the detected object is increased more rapidly. Conversely, if the sensor source has higher noise levels, the probability accumulates more slowly, reflecting the lower confidence in the detection accuracy. This dynamic adjustment of probabilities ensures a reliable and accurate representation of the environment.

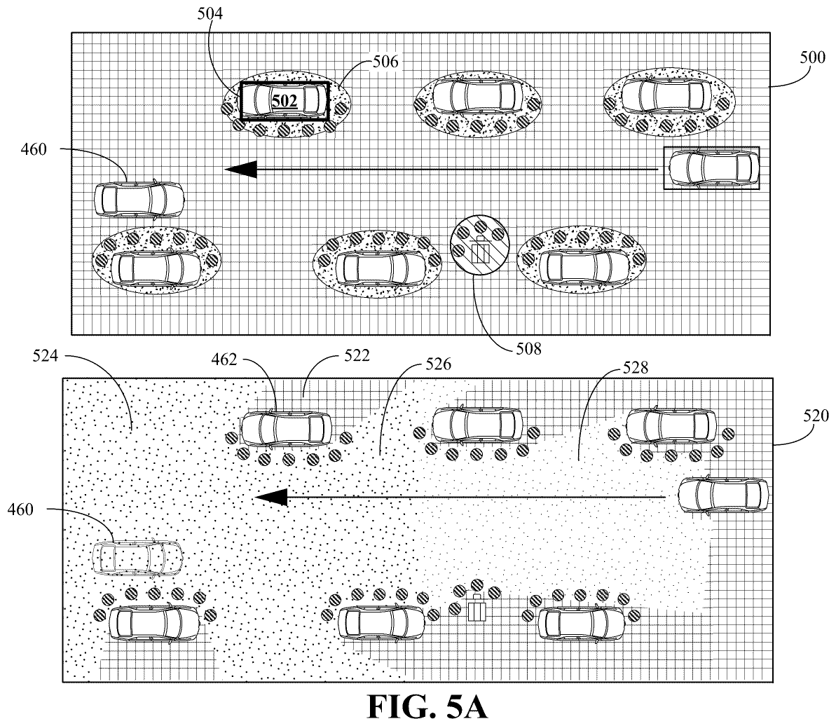

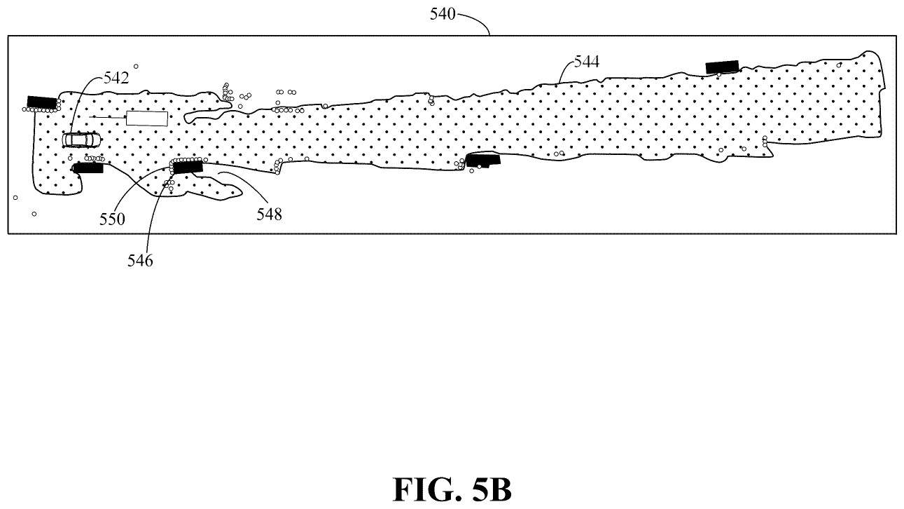

FIG. 5A-5B illustrate the accumulation phase of hazard evidence into an evidence grid. As mentioned above, during the accumulation phase, visible space, objects, and static hazards are accumulated into (e.g., added or updated to) the evidence grid.

An evidence grid 500 of FIG. 5A illustrates the accumulation of hazards and non-drivable points based on identified objects within the map frame of the ego vehicle 460 of FIGS. 4B-4C. The grid cells, such as the grid cells 502, within the evidence grid 500 represent areas where hazards from tracked objects, such as vehicles, pedestrians, and cyclists, have been detected. These grid cells indicate higher probabilities of hazard presence due to consistent sensor readings. The grid cells 502 include those within a bounding box 504 (e.g., a boundary) drawn by the process 300 around an observed or detected object in the map frame of the ego vehicle 460. The process 300 draws bounding boxes around each of the identified objects in the map frame.

Grid cells within augmented areas around objects, such as an augmented area 506, depict regions indicating areas of lower probability for hazard presence. This inconsistency (e.g., uncertainty) may result from prediction inaccuracies or sensor noise, affecting the accumulation of hazard data in grid cells within the augmented areas. Grid cells within the augmented areas are associated with lower confidence in the presence of hazards due, for example, to the aforementioned factors.

Additionally, the grid cells 508 represent non-drivable points, which are areas detected as obstacles that the ego vehicle 460 should avoid. These points are identified by the perception module but are associated with an unclassified (e.g., unrecognized) object. An unclassified object may be a curb, a trash can, or some other stationary barrier. Similar to the augmented area 506, certain of the grid cells 508 may also be associated with variability in detection confidence.

An evidence grid 520, which is the same as the evidence grid 500, illustrates the accumulation of visible space. The evidence grid 520 is used to accumulate and represent data regarding visibility around the ego vehicle 460 of FIG. 4B. Non-visible (occluded) grid cells, such as those in region 522, are obstructed by the object 462 of FIG. 4B, making them less visible to the sensors of the ego vehicle 460.

Grid points closer to the ego vehicle 460 have higher visibility (i.e., higher visibility probabilities) than those further away from the ego vehicle 460. For example, grid points in an area 524, which is nearer to the ego vehicle 460, have higher visibility than grid point in an area 526, which is further away. Similarly, grid points in the area 526 have higher visibility than grid points in an area 528, which is even further away from the ego vehicle 460. To be clear, it is noted that the grid points in an area do not necessarily all have the same visibility probability.

The differences in densities of the points in the areas 524 through 528 are intended to illustrate a gradual fading of visibility representing lower visibility of regions further away from the ego vehicle 460.

As already described, the higher visibility of closer grid points can be due to the proximity of these points to the sensors on the ego vehicle 460. Sensors, such as cameras, LiDAR, and radar, have greater accuracy and fewer obstructions when detecting objects and spaces closer to their location. As the distance from the ego vehicle increases, the likelihood of occlusions, environmental interference, and sensor noise also increases, resulting in reduced visibility and confidence in the detection of hazards.

The degree of visibility of a grid point is based on the frequency of observation over time. Grid points that are observed more frequently by the sensors have higher visibility probabilities. These probabilities indicate the confidence level that the grid points are within the line-of-sight and accurately reflect the surrounding environment. For example, the visibility probability of a grid point in area 524 is higher than that of a grid point in area 526, which in turn is higher than that of a grid point in area 528. This probabilistic approach allows the process 300 to account for varying sensor reliability and environmental conditions.

The evidence grid is dynamically updated to reflect the real-time visibility and hazard detection around the ego vehicle 460. By continuously monitoring and adjusting the visibility probabilities of the grid points, the system ensures a comprehensive understanding of the surrounding environment, enhancing the safety and navigation capabilities of the ego vehicle.

FIG. 5B illustrates a visualization 540 of an evidence grid. The visualization 540 includes an ego vehicle 542. The visualization 540 also illustrates a visibility field 544 illustrating the degrees of visibility of the grid points within the visibility field. The visualization 540 also includes identified hazards, such as an object 546, which may be classified as a parked vehicle. The visibility field includes a set of non-visible grid points 548 occluded by the object 546. The visualization 540 also includes non-drivable points shown as white filled circles, such as a grid point 550.

Referring is now again made to FIG. 3. At 318, dynamic hazards are further classified based on a reference path and speed plan 320 of the ego vehicle. Dynamic hazards may include slow crossing hazards (SCHs), as described herein. In some cases, an SCH may be re-classified as a static hazard based on further observation and/or a rate of change of the SCH satisfying a threshold. The reference path and speed plan 320 can be received from a planning module (not shown) of the ego vehicle. The process 300 may receive or access a portion of the reference path and speed plan 320 corresponding to a real-time planning horizon (e.g., 6 or 10 seconds).

The reference path can be a center line that is derived from a HD or standard-definition (SD) map. The reference path serves as a very rough path that the ego vehicle is intended to follow, typically representing the middle of the lane the vehicle aims to navigate.

This path is not yet refined and provides a general trajectory for the vehicle to reach its destination. The reference path may include waypoints and directional information, guiding the vehicle along the desired route. The reference path is typically updated in real-time to account for dynamic changes in the environment, such as road conditions, traffic, obstacles, and identified objects.

The speed plan defines a desired speed of the ego vehicle along the reference path. In the absence of external factors such as objects or obstacles, the speed plan represents the ideal speed profile for the vehicle. This plan is sometimes referred to as a strategic speed plan. The speed plan considers factors such as speed limits, road conditions, and the vehicle's performance capabilities to determine the optimal speed for each segment of the journey. By integrating the speed plan with the reference path, the ego vehicle can achieve a smooth and controlled driving experience, adhering to safety regulations and optimizing travel time.

Depending on the reference path and speed plan 320, the dynamic (i.e., moving) objects may be sub-classified differently. For example, a dynamic object may be sub-classified as a leading vehicle, an oncoming vehicle, a following vehicle, a parallel vehicle, or some other sub-classification. The sub-classification of a dynamic object can be based on a path (e.g., a hypothesis) predicted for the dynamic object.

At 322, interaction locations between the ego vehicle and some of the identified world objects are identified. Identifying the interaction locations with respect to a dynamic object may include determining the potential points in space and time where the paths of the ego vehicle and the dynamic object are predicted to intersect or come into proximity. The process 300 uses the reference path and speed plan 320 of the ego vehicle, along with the predicted paths and velocities of the dynamic objects, to estimate where interactions are likely to occur. This estimation takes into account the current positions, velocities, and predicted trajectories of all dynamic objects, such as leading vehicles, oncoming vehicles, following vehicles, parallel vehicles, and pedestrians.

Identifying the interaction locations may include several sub-steps: Predicting future positions, calculating interaction zones, and updating the evidence grid. In an example, identifying the interaction locations may also include assessing risk levels.

With respect to predicting future positions, the process 300 forecasts the future positions of dynamic objects based on their current motion patterns and any known behaviors (e.g., a vehicle changing lanes or a pedestrian crossing the street). With respect to calculating interaction zones, the process 300 may use the predicted future positions to calculate the zones of potential interactions. An interaction zone is an area where the ego vehicle is said to interact with a hazard over a planning horizon. With respect to updating the evidence grid, the process 300 integrates the interaction zones into the evidence grid, providing a dynamic and comprehensive map of potential hazards. With respect to assessing risk levels, the process 300 may assess the risk levels associated with each interaction zone by considering factors such as relative speeds, distances, and the types of dynamic objects involved. Higher risk levels can be assigned to zones where collisions or near-misses are more likely, enabling processes of the ego vehicle to focus on mitigating the most dangerous interactions first.

At 324, at least some of the interaction areas may be adjusted. This involves refining the previously identified interaction locations between the ego vehicle and dynamic objects, as well as other objects based on their classifications. Adjustments are made to account for uncertainties in the predictions, such as the predicted paths of dynamic objects, and to add safety buffers and contingencies to the interaction areas. Such adjustments enable the planning of safer paths. At 326, the above identified data related to dynamic hazards are accumulated in the evidence grid.

At 328, boundaries are adjusted based on the reference path and speed plan 320, if available. Right and left boundary constraints are determined based on the evidence grid. That is, the right and left boundary constraints are determined (e.g., set) based on the non-drivable points, the identified hazards, the interaction areas, the adjusted static hazards, and other data accumulated in the evidence grid.

Each grid cell on the left and right boundaries can be classified according to classifications including a first, second, and third constraint classification. The first classification indicates that no hazard (e.g., risk) is found within the boundary limit associated with the grid cell. The second classification indicates that only risk from non-drivable points (e.g. curbs, trash cans, or other non-classified objects) is identified. The third classification indicates the presence of risk from identified hazards such as vehicles, pedestrians, cyclists, etc. where additional information (e.g., a hazard type and the object identifier) are associated with the grid cells.

At 330, a valid path centerline and real-time speed plan through (e.g., based on) the evidence grid is searched (e.g., identified). At 332, the evidence grid can be parsed for useful information. The useful information may be transmitted to different modules of the ego vehicle. The information may be transmitted in any suitable data format. In an example, the Robot Operating System (ROS) format can be used. ROS implements a publisher and subscriber framework and is an open-source middleware framework commonly used in robotics applications, including autonomous vehicles, to provide a structured communications layer above host operating systems. The useful information may be communicated to one or more modules or processes 334 of the ego vehicle.

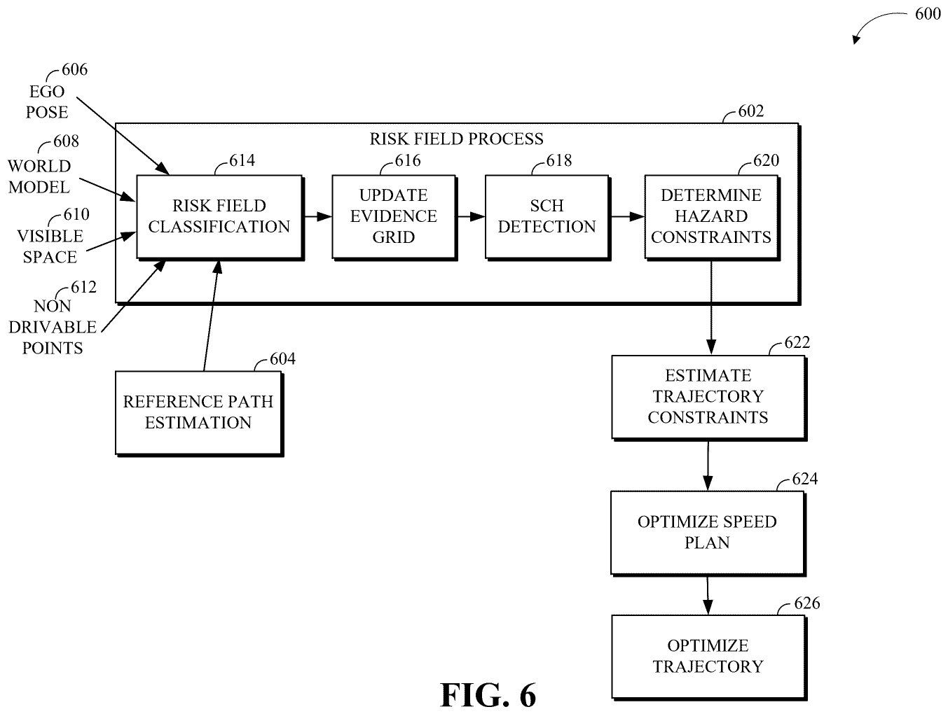

FIG. 6 is a block schematic diagram of an example 600 of a process for navigating an autonomous vehicle in accordance with the present disclosure. The process illustrated in FIG. 6 may be implemented by one or more processors, such as the processor 120 of FIG. 1, executing instructions stored in a memory, such as the memory 122 of FIG. 1.

The process begins with a risk field process 602, which may include obtaining a risk field comprising an evidence grid established in a map frame associated with an autonomous vehicle. The risk field process 602 may receive inputs from various sources, including an ego pose 606, a world model 608, visible space 610, and non-drivable points 612. These inputs are used to update and maintain the evidence grid, which serves as a comprehensive representation of the environment surrounding the autonomous vehicle.

The ego pose 606 may include information about the position and orientation of the autonomous vehicle within the environment. This information may be obtained from various sensors, such as GPS receivers, inertial measurement units (IMUs), and odometry sensors. The world model 608 may provide information about objects and hazards in the environment, including their classifications, positions, and predicted trajectories. The visible space 610 may represent areas that are currently visible to the vehicle's sensors, while the non-drivable points 612 may indicate areas that are not suitable for vehicle navigation, such as curbs, barriers, or other obstacles.

A reference path estimation 604 process may run in parallel with the risk field process 602. The reference path estimation 604 may generate a reference path for the autonomous vehicle based on various factors, such as the vehicle's destination, road network information, and current traffic conditions. This reference path serves as a general guide for the vehicle's intended route and may be continuously updated as new information becomes available.

The outputs of the risk field process 602 and the reference path estimation 604 are fed into a risk field classification 614 process. This process may classify various elements within the risk field, including static and dynamic hazards, based on their characteristics and potential impact on the vehicle's navigation. For example, a dynamic object may be classified as a slow crossing hazard (SCH) if it is determined to be moving slowly across the vehicle's intended path.

Following the risk field classification 614, the process updates the evidence grid at 616. This step may involve accumulating new information about hazards, updating probabilities associated with existing hazards, and adjusting the visibility levels of different grid cells. The updated evidence grid provides a current and comprehensive view of the environment, which is crucial for safe and efficient navigation.

The process then moves to SCH detection 618, where it specifically focuses on identifying and analyzing slow crossing hazards. This step may involve various techniques, such as boundary intrusion detection, object intrusion detection, and lead vehicle hazard detection.

These techniques allow the system to identify potential hazards that may not be immediately apparent but could pose significant risks if not properly addressed.

Based on the detected SCHs and other hazards identified in the risk field, the process determines hazard constraints at 620. These constraints may include speed limitations, stopping points, or areas to avoid. The hazard constraints are crucial for ensuring the safety of the autonomous vehicle and its occupants, as well as other road users.

The process then estimates trajectory constraints at 622. This step takes into account the hazard constraints, the reference path, and other factors to determine the feasible trajectories for the vehicle. The trajectory constraints ensure that the vehicle's planned path avoids identified hazards while still making progress towards its destination.

Using the trajectory constraints and other information from the previous steps, the process optimizes the speed plan at 624. This optimization may involve adjusting the vehicle's speed profile to safely navigate around hazards, comply with traffic regulations, and maintain passenger comfort. The optimized speed plan provides a balance between safety and efficiency in the vehicle's operation.

Finally, the process optimizes the trajectory at 626. This step combines all the previous information and constraints to generate an optimal path for the vehicle to follow. The optimized trajectory takes into account the reference path, identified hazards, speed constraints, and other factors to produce a safe and efficient route for the vehicle.

In some implementations, the process may include additional steps or variations of the steps shown in FIG. 6. For example, the system may incorporate machine learning algorithms to improve its hazard detection and classification over time. Additionally, the process may include provisions for handling edge cases or unexpected situations, such as sensor failures or sudden changes in road conditions.

It should be noted that while FIG. 6 illustrates a specific sequence of steps, in some implementations, certain steps may be performed in parallel or in a different order. The specific implementation may depend on factors such as the available computational resources, the complexity of the environment, and the specific requirements of the autonomous vehicle system.

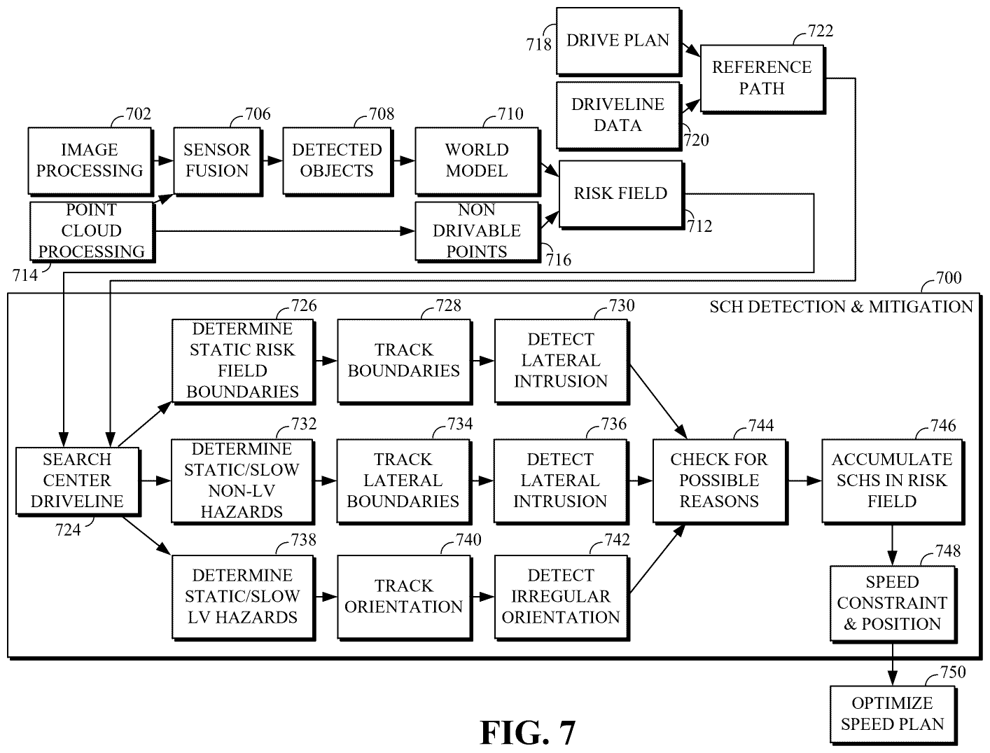

FIG. 7 is a block schematic diagram of an example of a process 700 for detecting and mitigating slow crossing hazards (SCHs) in accordance with the present disclosure. The process 700 may be implemented by one or more processors, such as the processor 120 of FIG. 1, executing instructions stored in a memory, such as the memory 122 of FIG. 1.

The process 700 begins with sensor data processing, which includes image processing 702 and point cloud processing 704. These processing steps may involve analyzing data from various sensors, such as cameras and LiDAR sensors, to detect objects and features in the environment surrounding the autonomous vehicle. The outputs of these processing steps are then combined through sensor fusion 706, which integrates the data from multiple sensors to create a more comprehensive and accurate representation of the environment.

The sensor fusion 706 outputs detected objects 708, which are used to update a world model 710. The world model 710 maintains a representation of the environment, including the positions, velocities, and classifications of various objects. In parallel, the point cloud processing 714 outputs non-drivable points 716, which represent areas that are not suitable for vehicle navigation, such as curbs, barriers, or other obstacles.

The process 700 also incorporates a drive plan 718 and driveline data 720, which are used to generate a reference path 722 for the autonomous vehicle. This reference path serves as a general guide for the vehicle's intended route and may be continuously updated as new information becomes available. The reference path 722 is then used in conjunction with the non-drivable points 716 to search for a center driveline 724 that accounts for the accumulated hazards while following the reference path closely.

Using the center driveline 724 and the accumulated hazards, the process determines static risk field boundaries 726. These boundaries represent the limits of safe navigation based on the current understanding of the environment. The process then tracks these boundaries 728 over time and detects any lateral intrusion 730 that may indicate the presence of a slow crossing hazard.

In parallel with the boundary tracking, the process also determines static and/or slow non-lead vehicle (LV) hazards 732. This involves tracking the lateral boundaries 734 of objects classified as stationary or slow-moving, and detecting any lateral intrusion 736 that may indicate a potential SCH. Additionally, the process determines static and/or slow lead vehicle hazards 738 by tracking the orientation 740 of lead vehicles and detecting any irregular orientation 742 that may suggest a potential SCH.

For each potential SCH identified through these detection methods, the process checks for possible reasons 744 that may explain the observed behavior. This step helps to reduce false positives by considering factors such as map data, predicted trajectories, and known traffic patterns. If no other explanation is found, the process accumulates the SCH data in the risk field 746.

Based on the accumulated SCH data, the process establishes speed constraints and positions 748 to mitigate the potential risks posed by the detected SCHs. These constraints may include reducing the vehicle's speed or, in some cases, bringing the vehicle to a complete stop at a safe distance from the potential hazard. The process then optimizes the speed plan 750 to ensure safe and efficient navigation around the detected SCHs.

In some implementations, the process 700 may include additional steps or variations to enhance its effectiveness. For example, the process may incorporate machine learning algorithms to improve its ability to distinguish between true SCHs and benign objects or movements. These algorithms could analyze historical data to identify patterns and features that are indicative of SCHs, allowing for more accurate and timely detection.

The process 700 may also be adapted to handle different types of environments and driving scenarios. For instance, in urban areas with high pedestrian activity, the SCH detection algorithms may be tuned to be more sensitive to sudden movements from sidewalks or crosswalks. In highway scenarios, the process may focus more on detecting slow-moving vehicles or debris on the road. Furthermore, the process 700 may be integrated with other systems of the autonomous vehicle to provide a more comprehensive approach to safety. For example, the SCH detection and mitigation process could inform the vehicle's path planning algorithms, allowing for proactive adjustments to the vehicle's trajectory to avoid potential hazards before they become immediate threats.

In some aspects, the process 700 may include a feedback loop that allows it to learn and improve over time. By analyzing the outcomes of its decisions, the system could refine its detection and mitigation strategies, potentially reducing false positives and improving the overall efficiency of the autonomous vehicle's navigation. The process 700 may also be designed to handle edge cases and unexpected situations. For instance, it may include provisions for dealing with sensor failures or inconsistencies in the data. In such cases, the system could rely on redundant sensors or fall back to more conservative driving behaviors to ensure safety.

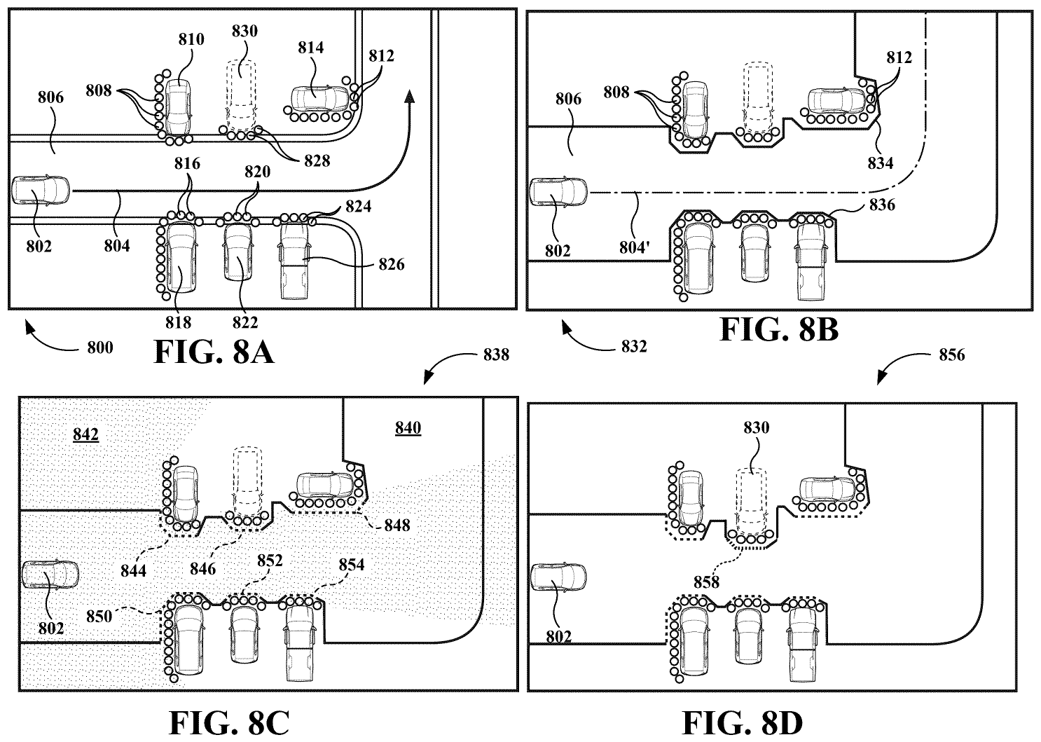

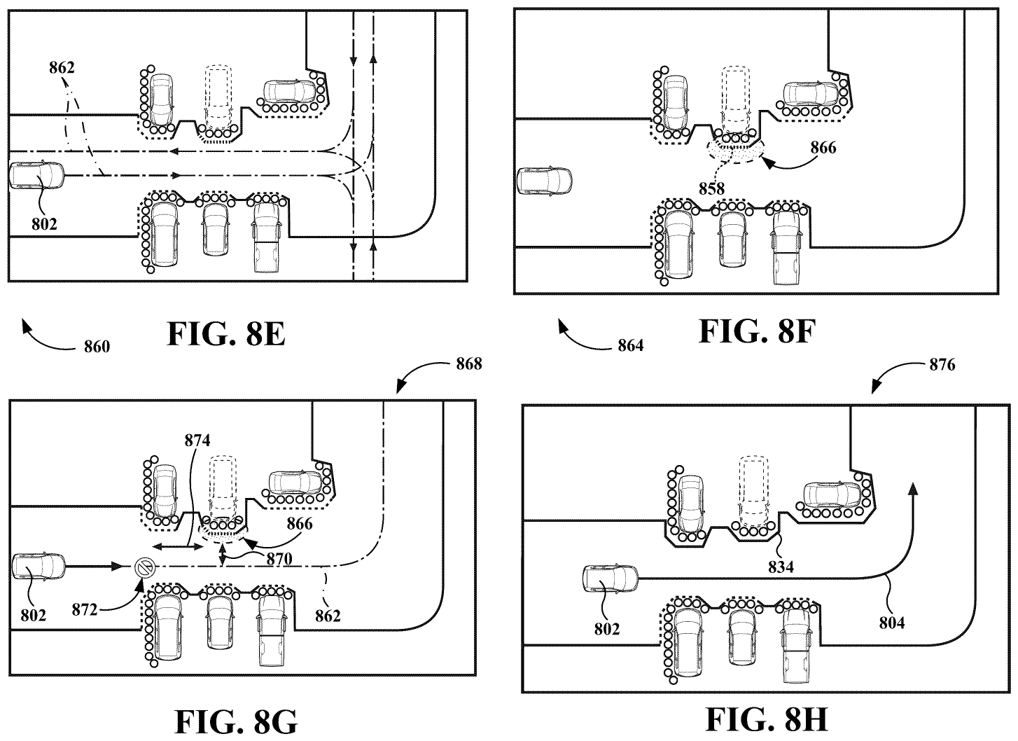

FIGS. 8A-8H illustrate an example associated with a boundary intrusion detection process in accordance with the present disclosure. This process may be implemented as part of the SCH detection 618 shown in FIG. 6 and may be a component of the process 700 described in FIG. 7.

FIG. 8A shows an example 800 associated with an initial step of the process. As shown in FIG. 8A, an ego vehicle 802 may be traveling along a reference path 804 on a road 806. The ego vehicle 802 may obtain sensor perception (e.g., LiDAR data) indicative of non-drivable points, which may be provided to a risk field. The non-drivable points may be accumulated as static hazards in the evidence grid. The non-drivable points represent surface boundaries detected above the ground-level plane, which may include curbs, trees, undetected vehicles, and other obstacles. In example 800, various parked vehicles (810, 814, 818, 822, 826) and an undetected vehicle 830 are represented by their associated non-drivable points (808, 812, 816, 820, 824, 828).

FIG. 8B illustrates an example 832 associated with the next step in the process. Based on the ego vehicle's reference path 804, a path search algorithm may be employed to determine an optimal driveline 804′ that accounts for the accumulated hazards while closely following the reference path 804. The process then searches laterally from this optimal driveline 804′, parsing the adjacent risk field grids for evidence of static or slow hazards. The evidence of static or slow hazards may be represented by static risk field boundaries. Example 832 shows a left static risk field boundary 834 and a right static risk field boundary 836.

An example 838 associated with a next step in the process is shown in FIG. 8C. In FIG. 8C, the left and right static risk field boundaries 834 and 836 are classified to identify possible SCH candidates. This classification may be based on the local region's visibility level, which is determined by factors such as line-of-sight and visible duration. For example, FIG. 8C shows a low visibility area 840 and a high visibility area 842. A number of SCH candidates 844, 846, 848, 850, 852, and 854 are identified along the left and right static risk field boundaries 834 and 836.

FIG. 8D shows an example 856 associated with a boundary tracking process. The boundaries may be tracked using software components referred to as boundary trackers. The boundary trackers may obtain raw boundary data and may process the boundary data through a noise filter. When an intrusion beyond the background sensor noise level is detected, the SCH classification may be triggered. In example 856, the boundary trackers may classify an SCH boundary 858 based on a detected intrusion associated with the undetected vehicle 830.

FIG. 8E shows another example 860 associated with the boundary tracking process. As shown, multiple map drivelines 862 may be identified (which may include the optimal driveline 804′). In some aspects, prior to classification of the SCH boundary 858, the ego vehicle 802 may perform assessments to verify that there are no other possible explanations for the boundary's motion. This may include checking against adjacent object predictions, map lanes, and world model predictions. If the boundary is positioned on previously accumulated SCH data in the risk field, the SCH classification may be applied more quickly.

FIG. 8F shows an example 864 associated with the accumulation of SCH evidence 866 in the surrounding local evidence grids within the risk field. FIG. 8G shows another example 868 associated with the boundary intrusion detection process. In FIG. 8G, the evidence grids along the ego vehicle's path 804 (and/or the drivelines 862) are parsed, and the SCH is detected. A position and speed constraint is determined based on the SCH probability and the SCH position relative to the ego path. The relative lateral distance 870 to the driveline 862 (which may be a reference path) is considered in this determination. Initially, the speed constraints may only slow down the ego vehicle. However, once the SCH intensity and lateral distance to the ego path cross a threshold, a 0-speed constraint may be determined, causing the ego vehicle to stop at a constraint position 872 before the SCH location. The constraint position 872 may be at least a full car's length from the hazard to allow for sufficient maneuvering space.

FIG. 8H shows another example 876 associated with the boundary intrusion detection process. The example 876 illustrates the scenario where the boundary 834 stops moving towards the ego vehicle's path 804. In this case, the SCH classification may be removed, and the SCH belief in the risk field will gradually reduce. Once the SCH belief reduces below a threshold, the speed constraint may be removed, allowing the ego vehicle 802 to resume its path 804.

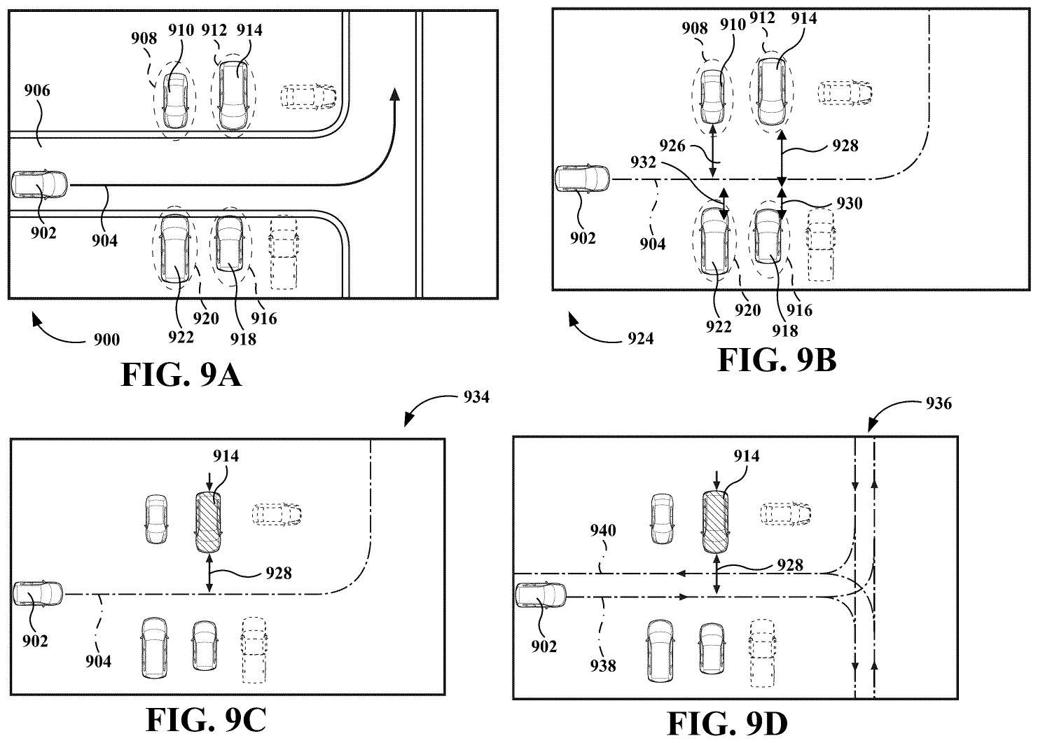

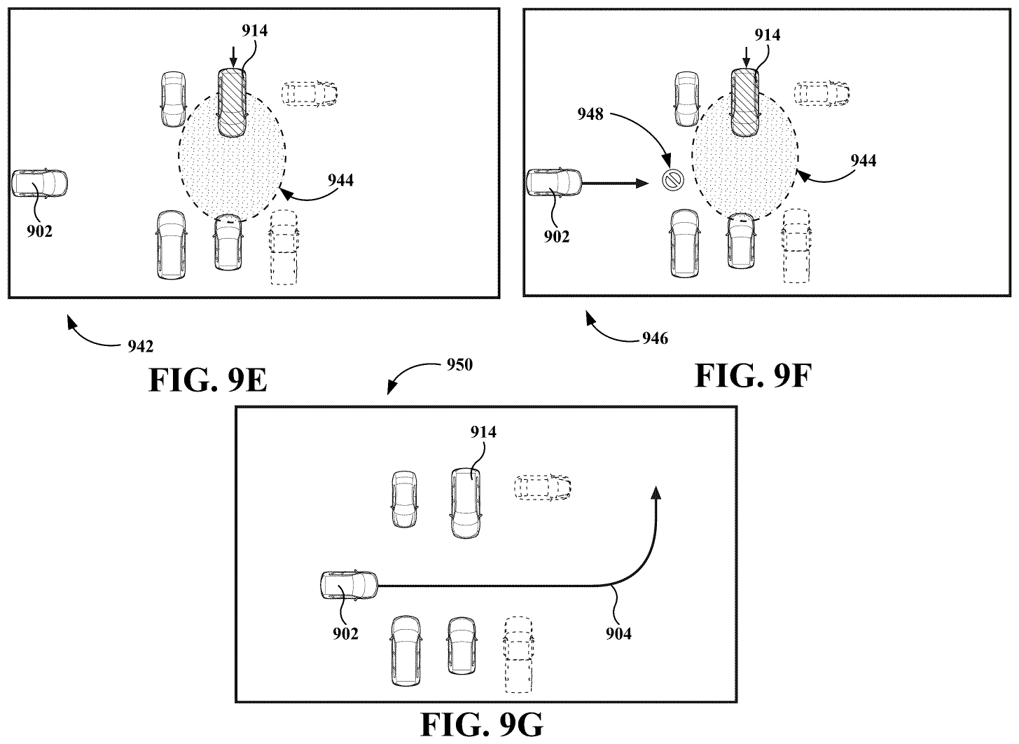

FIGS. 9A-9G illustrate an example of an object intrusion detection process in accordance with the present disclosure. This process may be implemented as part of the SCH detection 618 shown in FIG. 6 and may be a component of the process 700 described in FIG. 7.

FIG. 9A shows an example 900 associated with an initial step of the process, where objects tracked to be stationary are classified as static hazards and accumulated in the risk field. In some cases, objects moving very slowly may also be tracked as stationary. Example 900 shows an ego vehicle 902 having a reference path 904 on a road 906. Several parked vehicles (910, 914, 918, 922) are represented by their associated hazard accumulations (908, 912, 916, 920) in the risk field.

FIG. 9B shows an example 924 associated with a next step in the process. The system searches among the accumulated hazards in the Risk Field and parses those adjacent to the ego vehicle's reference path 904. The boundaries of these hazards relative to the ego's path are then tracked over time. Example 924 shows relative lateral distances (926, 928, 930, 932) between the parked vehicles and the reference path 904.

FIG. 9C shows another example 934 associated with the object intrusion detection process. In example 934, the system determines if the intrusion motion of the object boundaries is above the sensor noise level. If so, the object (in the illustrated case, the vehicle 914) may be labeled as a possible candidate for an SCH. The classification process may be expedited if the object is positioned on previously accumulated SCH data in the Risk Field.

FIG. 9D shows another example 936 associated with the object intrusion detection process. FIG. 9D may involve performing assessments to verify that there are no other possible explanations for the object's movement. This may include checking against intersection lanes and the world model's map-based predictions. The figure shows map drivelines (938, 940) which may be used in this assessment process.

FIG. 9E shows another example 942 associated with the object intrusion detection process. Example 942 shows the accumulation 944 of SCH data in the risk field once the vehicle 914 is classified as an SCH. FIG. 9F shows another example 946 associated with the object intrusion detection process. In example 946, the evidence grids along the ego vehicle's path are parsed, and the SCH is detected. Based on the SCH probability and its position relative to the ego path, a position and speed constraint may be determined. If the SCH intensity and lateral distance to the ego path cross a threshold, a 0-speed constraint may be applied, causing the ego vehicle 902 to stop at a position before the SCH location. This stop position, indicated by the SCH constraint position 948, may be at least a full car's length from the hazard to allow for sufficient maneuvering space.

FIG. 9G shows another example 950 associated with the object intrusion detection process. Example 950 illustrates the scenario where the vehicle 914 stops moving towards the ego vehicle's path 904. In this case, the SCH classification may be removed, and the SCH belief in the risk field will gradually reduce. Once the SCH belief reduces below a threshold, the speed constraint may be removed, allowing the ego vehicle 902 to resume its path 904.

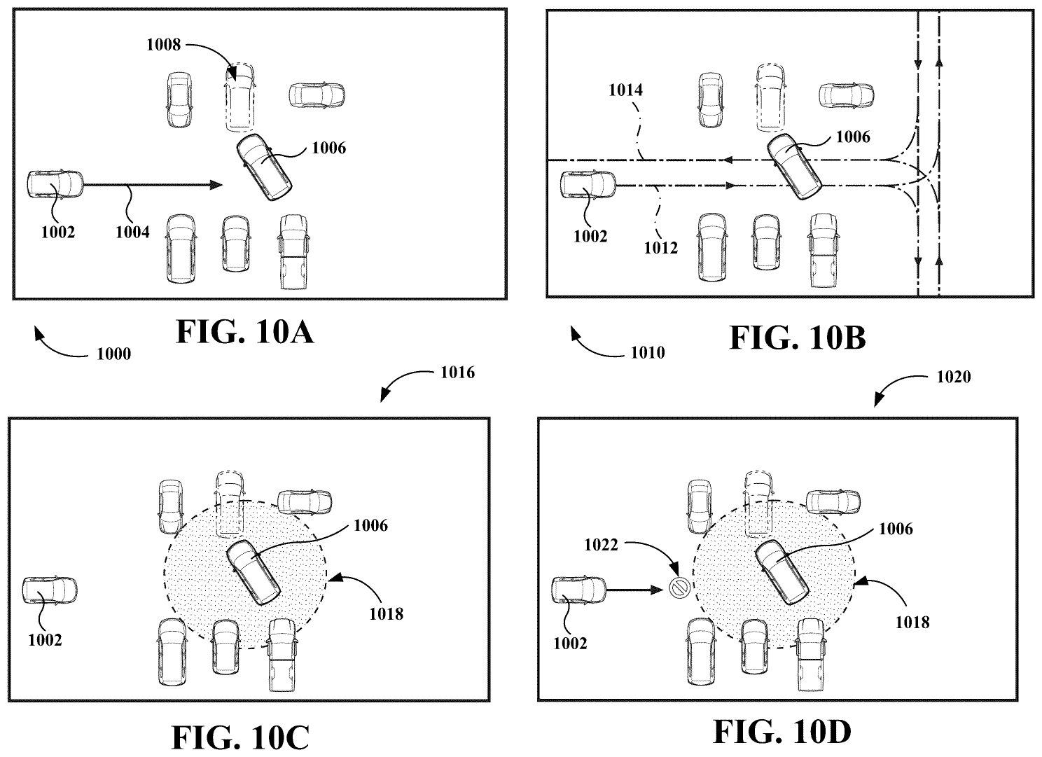

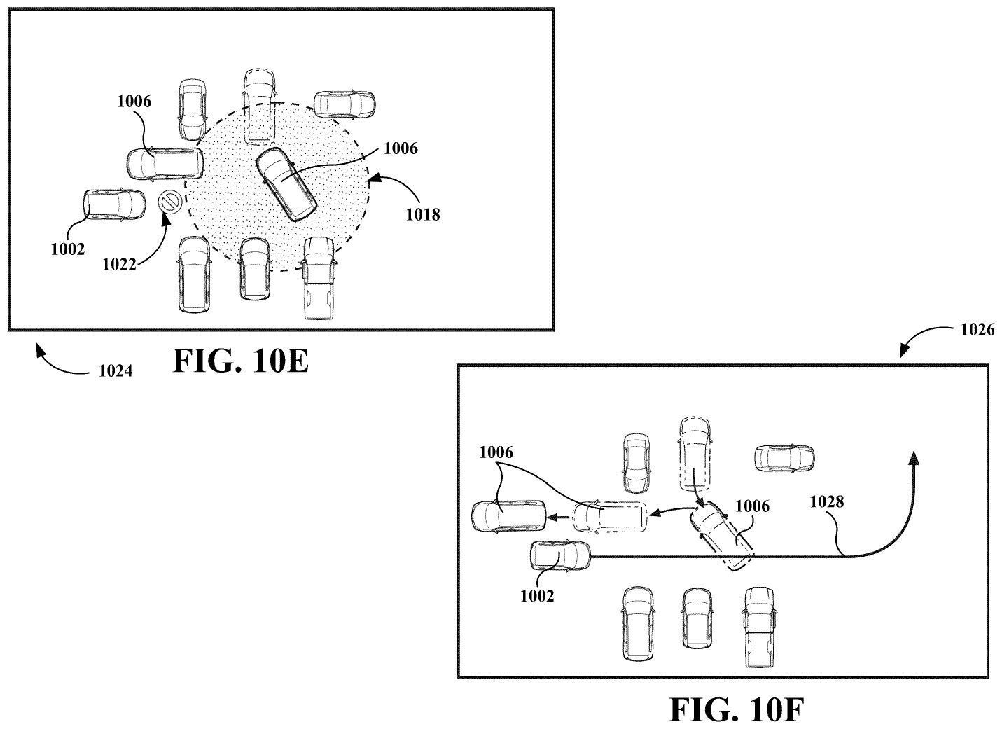

FIGS. 10A-10F illustrate an example of a lead vehicle intrusion detection process in accordance with the present disclosure. This process may be implemented as part of the SCH detection 618 shown in FIG. 6 and may be a component of the process 700 described in FIG. 7.

FIG. 10A shows an example 1000 associated with an initial step of the process, where objects classified as lead vehicles (LVs) are monitored for irregular orientations. In example 1000, an ego vehicle 1002 is shown with its reference path 1004. A lead vehicle 1006 is depicted in its initial position 1008. Slow or stationary lead vehicles with irregular orientations may be considered candidates for SCHs.

FIG. 10B shows another example 1010 associated with the lead vehicle intrusion detection process. The system performs checks to verify that there are no other possible explanations for the lead vehicle's orientation. This may include examining intersection lanes and the world model's map-based predictions. Example 1010 shows map drivelines 1012 and 1014, which may be used in this assessment process. If the lead vehicle 1006 is positioned on previously accumulated SCH data in the risk field, the SCH classification may be applied more quickly.

FIG. 10C shows another example 1016 associated with the lead vehicle intrusion detection process. In example 1016, the process begins accumulating SCH data 1018 in the risk field once a lead vehicle 1006 is classified as an SCH. FIG. 10D shows another example 1020 associated with the lead vehicle intrusion detection process. Example 1020 demonstrates the constraint determination phase. The evidence grids along the ego vehicle's path are parsed, and the SCH is detected. Based on the SCH intensity and its position relative to the ego path, a position and maximum speed constraint is determined. If the SCH intensity and lateral distance to the ego path cross a threshold, a 0-speed constraint may be applied. This constraint, represented by the SCH constraint position 1022, causes the ego vehicle 1002 to stop at a position before the SCH location. The stopping distance may be at least a full car's length from the hazard to allow for sufficient maneuvering space.

FIG. 10E shows another example 1024 associated with the lead vehicle intrusion detection process. Example 1024 shows the scenario where the lead vehicle's orientation becomes regular, or it is no longer classified as a lead vehicle 1006. In this case, the SCH classification may be removed, and the accumulated SCH belief in the risk field gradually reduces over time. Example 1024 illustrates the diminishing SCH accumulation 1018 in the risk field.

FIG. 10F shows another example 1026 associated with the lead vehicle intrusion detection process. Example 1026 depicts the resumption of normal operation. Once the SCH belief is reduced below a threshold, the speed constraint is removed, and the ego vehicle resumes its path. This is represented by the resumed vehicle path 1028, showing the ego vehicle 1002 continuing along its intended route.

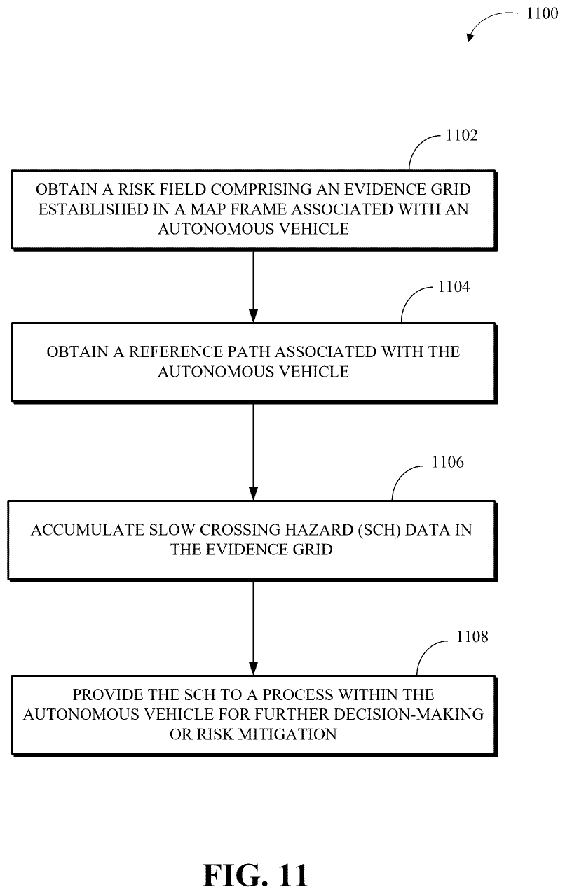

To further describe some implementations in greater detail, reference is next made to examples of techniques which may be performed for or using an evidence grid for vehicle navigation. FIG. 11 is a flowchart of an example of a technique 1100 for navigating an autonomous vehicle in accordance with the present disclosure. The technique 1100 can be executed using computing devices, such as the systems, hardware, and software described with respect to FIGS. 1-10F.

At 1102, a risk field comprising an evidence grid established in a map frame associated with an autonomous vehicle may be obtained. The risk field may include accumulated data about hazards, objects, and non-drivable points in the environment surrounding the autonomous vehicle. This step provides a comprehensive representation of the vehicle's surroundings, enabling more accurate and efficient navigation decisions.

At 1104, a reference path associated with the autonomous vehicle may be obtained. The reference path may be based on a drive plan and driveline data, providing a general trajectory for the vehicle to follow. This step allows the system to have a baseline path for navigation while considering potential hazards and obstacles.

At 1106, SCH data may be accumulated in the evidence grid. This accumulation may be performed by executing at least one of a boundary intrusion detection procedure, an object intrusion detection procedure, or a lead vehicle hazard detection procedure. These procedures enable the system to identify and track potential hazards that may cross the vehicle's path, even if they are moving slowly.

The boundary intrusion detection procedure may involve accumulating non-drivable points in the evidence grid based on sensor outputs, determining a driveline that accounts for these points while following the reference path, and classifying static risk field boundaries. This procedure allows for early detection of potential hazards that may not yet be fully visible or classified. The object intrusion detection procedure may include accumulating objects classified as stationary in the evidence grid, parsing the grid to identify objects adjacent to the reference path, and tracking their boundaries over time. This approach enables the system to detect when previously stationary objects begin to move and potentially become hazards. The lead vehicle hazard detection procedure may involve monitoring lead vehicles for irregular orientations and classifying them as potential SCHs when appropriate. This procedure helps identify situations where a lead vehicle may unexpectedly change its trajectory and become a hazard.

At 1108, the SCH data may be provided to a process within the autonomous vehicle for further decision-making or risk mitigation. This step ensures that the accumulated hazard data is utilized effectively to enhance the safety and efficiency of the vehicle's navigation.

The technique 1100 offers several advantages for autonomous vehicle navigation. By maintaining a comprehensive risk field in a map frame, the system can retain hazard information even when the vehicle's path changes, leading to more stable and consistent navigation. The use of multiple detection procedures provides redundancy and improves the system's ability to identify potential hazards in various scenarios. Furthermore, the accumulation of SCH data in the evidence grid allows for more nuanced speed and trajectory planning. The system can determine appropriate speed constraints and stopping positions based on the probability and position of detected SCHs relative to the vehicle's path. This approach enables the autonomous vehicle to navigate more safely in complex environments, particularly in situations involving slow-moving hazards that may be difficult to detect with traditional methods.

The technique also supports proactive risk mitigation by allowing the system to anticipate potential hazards before they become immediate threats. By continuously updating the evidence grid and assessing the risk of SCHs, the autonomous vehicle can make more informed decisions about when to slow down, stop, or adjust its trajectory. Additionally, by providing the SCH data to other processes within the autonomous vehicle, the technique enables a more holistic approach to navigation and safety. Other systems, such as path planning algorithms or driver assistance features, can benefit from this rich hazard data, further enhancing the overall performance and safety of the autonomous vehicle.

Herein, the terminology “passenger”, “driver”, or “operator” may be used interchangeably. Also, the terminology “brake” or “decelerate” may be used interchangeably. As used herein, the terminology “processor”, “computer”, or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some embodiments, instructions, or a portion thereof, may be implemented as a special-purpose processor or circuitry that may include specialized hardware for carrying out any of the methods, algorithms, aspects, or combinations thereof, as described herein. In some embodiments, portions of the instructions may be distributed across multiple processors on a single device, or on multiple devices, which may communicate directly or across a network, such as a local area network, a wide area network, the Internet, or a combination thereof.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein.

Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
obtaining a risk field comprising an evidence grid established in a map frame associated with an autonomous vehicle;
obtaining a reference path associated with the autonomous vehicle, wherein the reference path is based on a drive plan and driveline data;
accumulating slow crossing hazard (SCH) data in the evidence grid by performing at least one of a boundary intrusion detection procedure, an object intrusion detection procedure, or a lead vehicle hazard detection procedure; and
providing the SCH data to a process within the autonomous vehicle for further decision-making or risk mitigation.

2. The method of claim 1, wherein performing the boundary intrusion detection procedure comprises accumulating non-drivable points in the evidence grid, wherein each non-drivable point is based on an output of a sensor associated with the autonomous vehicle.

3. The method of claim 2, performing the boundary intrusion detection procedure further comprises:
determining a driveline that accounts for the non-drivable points while following the reference path;
parsing the evidence grid for evidence of at least one of static hazards or slow crossing hazards; and
classifying the at least one of the static hazards or the slow crossing hazards as static risk field boundaries.

4. The method of claim 3, wherein classifying the at least one of the static hazards or the slow crossing hazards comprises classifying the at least one of the static hazards or the slow crossing hazards based on a visibility of a local region.

5. The method of claim 4, wherein the visibility of the local region is based on at least one of a line-of-sight determination or a visible duration determination.

6. The method of claim 3, wherein classifying the at least one of the static hazards or the slow crossing hazards comprises classifying the at least one of the static hazards or the slow crossing hazards based on a position of the at least one of the static hazards or the slow crossing hazards relative to the reference path.

7. The method of claim 3, wherein classifying the at least one of the static hazards or the slow crossing hazards comprises:
filtering raw boundary data through a noise filter; and
detecting an intrusion beyond a sensor noise level.

8. The method of claim 1, wherein performing the object intrusion detection procedure comprises:
accumulating objects classified as stationary in the evidence grid;
parsing the evidence grid to identify at least one object that is adjacent to the reference path;
tracking a boundary of the at least one object over time; and
classifying the at least one object as a slow crossing hazard.

9. The method of claim 8, wherein classifying the at least one object as the slow crossing hazard comprises classifying the at least one object as the slow crossing hazard based on a sensor noise level.

10. The method of claim 1, wherein performing the lead vehicle hazard detection procedure comprises:
monitoring a lead vehicle for irregular orientations; and
classifying the lead vehicle as a slow crossing hazard.

11. The method of claim 1, wherein accumulating slow crossing hazard (SCH) data in the evidence grid comprises:
accumulating candidate SCHs in the evidence grid; and
performing an assessment to verify that there are no other possible explanations for the candidate SCHs.

12. The method of claim 1, further comprising:
determining a speed constraint based on an SCH probability; and
determining an SCH constraint position relative to the reference path.

13. The method of claim 12, wherein determining the speed constraint comprises determining a 0-speed constraint based on an SCH intensity and a lateral distance to the reference path.

14. The method of claim 13, further comprising stopping the autonomous vehicle at a stopping position before reaching the SCH constraint position.

15. The method of claim 14, wherein stopping the autonomous vehicle comprises stopping the autonomous vehicle at least a full car's length from the SCH constraint position.

16. A vehicle, comprising:
one or more sensors;
a memory; and
a processor configured to execute instructions stored in the memory to:
obtain a risk field comprising an evidence grid established in a map frame associated with an autonomous vehicle;
obtain a reference path associated with the autonomous vehicle, wherein the reference path is based on a drive plan and driveline data;
accumulate slow crossing hazard (SCH) data in the evidence grid by performing at least one of a boundary intrusion detection procedure, an object intrusion detection procedure, or a lead vehicle hazard detection procedure; and
provide the SCH data to a process within the autonomous vehicle for further decision-making or risk mitigation.

17. The vehicle of claim 16, wherein, to accumulate the slow crossing hazard (SCH) data in the evidence grid, the processor is configured to:
accumulate candidate SCHs in the evidence grid; and
perform an assessment to verify that there are no other possible explanations for the candidate SCHs.

18. The vehicle of claim 16, wherein the processor is further configured to:
determine a speed constraint based on an SCH probability; and
determine an SCH constraint position relative to the reference path.

19. A non-transitory computer-readable medium storing instructions operable to cause one or more processors to perform operations comprising:
obtaining a risk field comprising an evidence grid established in a map frame associated with an autonomous vehicle;
obtaining a reference path associated with the autonomous vehicle, wherein the reference path is based on a drive plan and driveline data;
accumulating slow crossing hazard (SCH) data in the evidence grid by performing at least one of a boundary intrusion detection procedure, an object intrusion detection procedure, or a lead vehicle hazard detection procedure; and
providing the SCH data to a process within the autonomous vehicle for further decision-making or risk mitigation.

20. The non-transitory computer-readable medium of claim 19, the operations further comprising:
determining a speed constraint based on an SCH probability; and
determining an SCH constraint position relative to the reference path.
